(19) United States
(12) Patent Application Publication
(10) Pub. No.: US 2013/0061194 A1
(43) Pub. Date: Mar. 7, 2013

(54) LAYOUT METHOD, LAYOUT APPARATUS, AND PROGRAM FOR SEMICONDUCTOR INTEGRATED CIRCUIT

(71) Applicant: Mitsuru HANDA, Kanagawa (JP)

(72) Inventor: Mitsuru HANDA, Kanagawa (JP)

(73) Assignee: RENESAS ELECTRONICS CORPORATION

(21) Appl. No.: 13/604,058

(22) Filed: Sep. 5, 2012

(30) Foreign Application Priority Data
Sep. 5, 2011 (JP) 2011-192949

(51) Int. Cl. G06F 17/50

(52) U.S. Cl. 716/122

(57) ABSTRACT

A layout method, upon performing layout of layer blocks each including internal elements, with respect to mounting area where internal element resources, to which internal elements can be assigned, are arranged, comprises: arranging, when first layer block and second layer block overlap in overlapping area, first layer block and the second layer block such that sum of number of first internal elements included in the overlapping area, among internal elements of first layer block, and number of second internal elements included in the overlapping area, among internal elements of second layer block, is not greater than number of internal element resources included in the overlapping area; and assigning the internal element resources included in the overlapping area to first layer block and second layer block, in accordance with ratio of number of first internal elements to number of second internal elements.

### TECHNICAL FIELD

### REFERENCE TO RELATED APPLICATION

This application is based upon and claims the benefit of the priority of Japanese patent application No. 2011-192949, filed on Sep. 5, 2011, the disclosure of which is incorporated herein in its entirety by reference thereto.

The present invention relates to a layout method, a layout apparatus, and a program for a semiconductor integrated circuit, and in particular relates to a layout method, a layout apparatus, and a program for performing layer layout design of a semiconductor integrated circuit having a plurality of layer blocks divided according to function.

### BACKGROUND

In layout design of a large scale semiconductor integrated circuit, there is a problem in that, when layout design is performed for an overall circuit all together, the circuit amount dealt with by one device becomes large, and design time increases. In recent years, carrying out layer layout design has become mainstream, as a method of solving this problem.

In general layer layout design, in a case of overlapping of layout areas of (floor) layer blocks that are treated as being divided, in order to overcome physical overlapping of internal elements formed of instances and wiring included in the layer blocks, it is necessary to change the position of at least one of the internal elements. According to the change in consideration, a timing constraint violation or a design rule violation may occur, so that the design time increases by the amount of time for the process of solving the timing constraint violation or the design rule violation. Thus there is a demand to shorten the overall design time.

Patent Literature 1, for example, describes a floor plan apparatus for efficiently designing a floor plan. The floor plan apparatus described in Patent Literature 1 performs layout processing with respect to a mounting area for a plurality of layout-target blocks in which internal elements are arranged, and is provided with: a provisional layout unit that provisionally arranges a plurality of layout-target blocks in a mounting area, so as to form an overlapping area (common area) where, among the plurality of layout-target blocks, at least 2 layout-target blocks mutually overlap, and an optimizing unit that optimizes the layout-target blocks by changing the layout, while using the overlapping area, of internal elements of at least one of the layout-target blocks among the layout-target blocks forming the overlapping area.

### Patent Literature 1]

JP Patent No. 4221045 (FIG. 1, FIG. 27)

### SUMMARY

The entire disclosure of Patent Literature 1 is incorporated herein by reference thereto. The following analysis is given by the present invention.

When layer layout design is performed based on a floor plan apparatus 1 described in Patent Literature 1, there is a problem due to increased design time necessary for the layout of an overall logical circuit (semiconductor integrated circuit).

A reason for this is as follows. In the (floor) layer layout design according to the floor plan apparatus 1 described in Patent Literature 1, in order to overcome physical interference of internal elements in a common area, it is necessary to change the position of at least one internal element. However, it becomes necessary to perform correction processing due to the occurrence of a design constraint violation caused by the position change(s) of the internal element(s), and thus the overall design time increases.

In a case where the internal element is an instance within a layer block, the wiring length of wiring connected to the instance and load capacitance change, due to the position of the instance being changed. Here, design constraints comprise timing constraints including setup timing and hold timing, and design rules including signal integrity, and they are dependent on wiring length and load capacitance. Therefore, in a case where there is no design margin in design constraints before a change of position, a design constraint violation occurs due to a change in the wiring length and load capacitance. In this case, modifications such as instance addition, instance removal, instance movement, and instance drive capability change, with respect to wiring, must be continually performed until the design constraint violation is resolved. Consequently, the design time increases.

On the other hand, in a case where an internal element is wiring in a layer block, the wiring length and load capacitance of wiring connected to the instance change, due to a change of the position of the wiring. Therefore, similar to the case where the internal element is an instance in a layer block, the design time increases.

Accordingly, when performing layout design while allowing a plurality of layer blocks to mutually overlap, there is a need in the art to prevent an increase in the design time.

According to a first aspect of the present disclosure, there is provided a layout method, the method comprising performing layout of a plurality of layer blocks each including a plurality of internal elements, while allowing mutual overlapping, with respect to a mounting area where internal element resources, to which internal elements can be assigned, are arranged. The method further comprises:
arranging, in a case where a first layer block and a second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area, and
assigning the internal element resources included in the overlapping area to the first layer block and the second layer block, in accordance with a ratio of the number of the first internal elements to the number of the second internal elements.

According to a second aspect of the present disclosure, there is provided a layout apparatus, the layout apparatus performing layout of a plurality of layer blocks each including a plurality of internal elements, while allowing mutual overlapping, with respect to a mounting area where internal element resources, to which internal elements can be assigned, are arranged. The apparatus comprises:
a layout unit that arranges, in a case where a first layer block and a second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area;
an overlapping information extracting unit that computes a ratio of the number of the first internal elements to the number of the second internal elements; and
a resource dividing unit that assigns the internal element resources included in the overlapping area to the first layer block and the second layer block, in accordance with the ratio.

According to a third aspect of the present disclosure, there is provided a non-transitory computer-readable storage medium that stores a program, the program causing a computer to execute performing layout of a plurality of layer blocks each including a plurality of internal elements, while allowing mutual overlapping, with respect to a mounting area where internal element resources, to which internal elements can be assigned, are arranged. The program further causes the computer to execute:
arranging, in a case where a first layer block and a second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area, and
assigning the internal element resources included in the overlapping area to the first layer block and the second layer block, in accordance with a ratio of the number of the first internal elements to the number of the second internal elements.

The present disclosure provides the following advantage, but not restricted thereto. With the layout apparatus, layout method and program according to the present disclosure, it is possible to prevent an increase in design time, when performing layout design while allowing a plurality of layer blocks to mutually overlap.

### BRIEF DESCRIPTION OF DRAWINGS

FIG. 1 is a flowchart showing an example of a layout method according to the present disclosure;

FIG. 2 is a block diagram showing an example of an outline configuration of a layout apparatus according to the present disclosure;

FIG. 3 is a block diagram showing an example of a configuration of a layout apparatus according to an exemplary embodiment;

FIGS. 4A and 4B are schematic diagrams showing layer block areas that are divided by the layout apparatus according to an exemplary embodiment;

FIGS. 5A and 5B are schematic diagrams showing a number of layouts and a number of wires for each divided area of the layer blocks according to the layout apparatus according to an exemplary embodiment;

FIGS. 6A to 6C are schematic diagrams showing overlapping areas where the positions of a plurality of layer blocks are changed by the layout apparatus according to an exemplary embodiment, and parts of the divided areas overlap each other;

FIG. 7 is a schematic diagram where area parts of layer block BLK_A and layer block BLK_B are arranged to overlap by the layout apparatus according to an exemplary embodiment, and an overlapping area OVER_AREA_01 is generated;

FIG. 8 is a schematic diagram representing internal element resources of an arbitrary area according to the layout apparatus according to an exemplary embodiment, as a collection of ROWs and TRACKs; and

FIG. 9 is a flowchart showing an example of operation of the layout apparatus according to an exemplary embodiment.

### PREFERRED MODES

In the present disclosure, there are various possible modes, which includes the following, but not restricted thereto. First, a description is given of an outline of the present disclosure. It is to be noted that reference symbols attached to the drawings in this outline are shown as examples solely for aiding understanding, and are not intended to limit the disclosure to modes of the drawings shown.

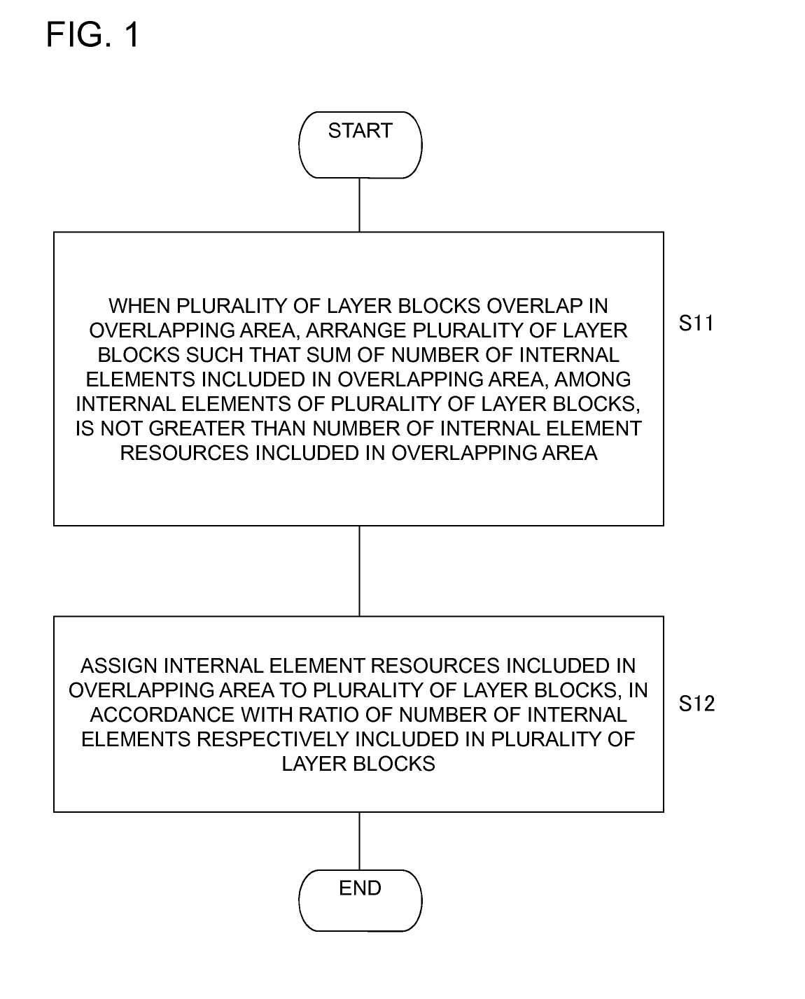

Referring to FIG. 1, a layout method according to the present disclosure is a method that performs layout of a plurality of layer blocks each including a plurality of internal elements, while allowing mutual overlapping, with respect to a mounting area where internal element resources, to which internal elements can be assigned, are arranged, the method comprising: arranging, in a case where a first layer block and a second layer block overlap in an overlapping area, the first layer block and the second layer block, such that a sum of a number of first internal elements included in the overlapping area, among internal elements of the first layer block, and a number of second internal elements included in the overlapping area, among internal elements of the second layer block, is not greater than a number of internal element resources included in the overlapping area (step S11); and assigning the internal element resources included in the overlapping area to the first layer block and the second layer block, in accordance with a ratio of the number of first internal elements to the number of second internal elements (step S12). Here, an internal element refers to a circuit element, wiring element, and the like, which logically configure a semiconductor device, and an internal element resource refers to a physical resource for implementing the circuit or wiring element on a mounting board of the semiconductor device.

The internal elements may include a layout element and a wiring element, and the internal element resources may include a layout resource to which the layout element can be assigned and a wiring resource to which the wiring element can be assigned.

In this case, the arranging (step S11) may comprise arranging the first layer block and the second layer block such a the sum of a number of first layout elements included in the overlapping area, among layout elements of the first layer block, and a number of second layout elements included in the overlapping area, among layout elements of the second layer block, is not greater than a number of layout resources included in the overlapping area, and that a sum of a number of first wiring elements included in the overlapping area, among wiring elements of the first layer block, and a number of second wiring elements included in the overlapping area, among wiring elements of the second layer block, is not greater than a number of wiring resources included in the overlapping area.

Furthermore, the assigning process (step S12) may comprise assigning layout resources included in the overlapping area to the first layer block and the second layer block in accordance with a ratio of the number of first layout elements to the number of second layout elements, and assigning wiring resources included in the overlapping area to the first layer block and the second layer block in accordance with a ratio of the number of first wiring elements to the number of second wiring elements.

The assigning process (step S12) may comprise assigning layout resources included in the overlapping area to the first layer block and the second layer block, such that a ratio of the layout resources assigned to the first layer block to the layout resources assigned to the second layer block is uniform in each part of the overlapping area. In addition, the assigning process (step S12) may comprise assigning wiring resources included in the overlapping area to the first layer block and the second layer block, such that a ratio of the wiring resources assigned to the first layer block to the wiring resources assigned to the second layer block is uniform in each part of the overlapping area.

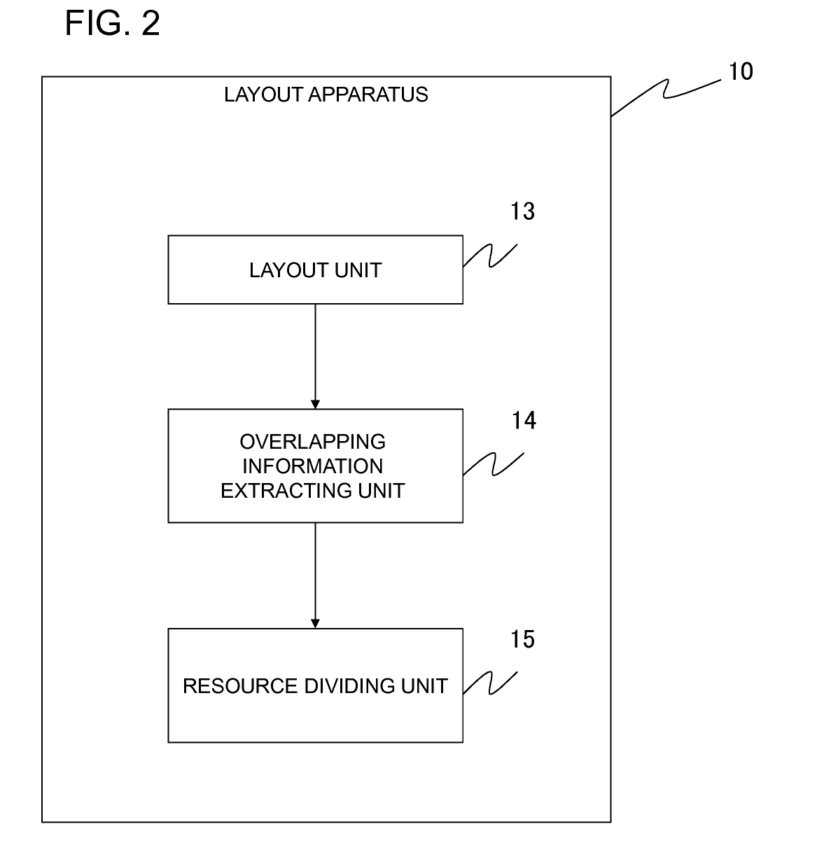

Referring to FIG. 2, the layout apparatus (10) according to the present disclosure is an apparatus that performs layout of a plurality of layer blocks each including a plurality of internal elements, while allowing mutual overlapping, with respect to a mounting area where internal element resources, to which internal elements can be assigned, are arranged, the layout apparatus may comprise a layout unit (13) that arranges, in a case where the first layer block and the second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area; an overlapping information extracting unit (14) that computes a ratio of the number of first internal elements to the number of second internal elements; and a resource dividing unit (15) that assigns the internal element resources included in the overlapping area to the first layer block and the second layer block, in accordance with the ratio.

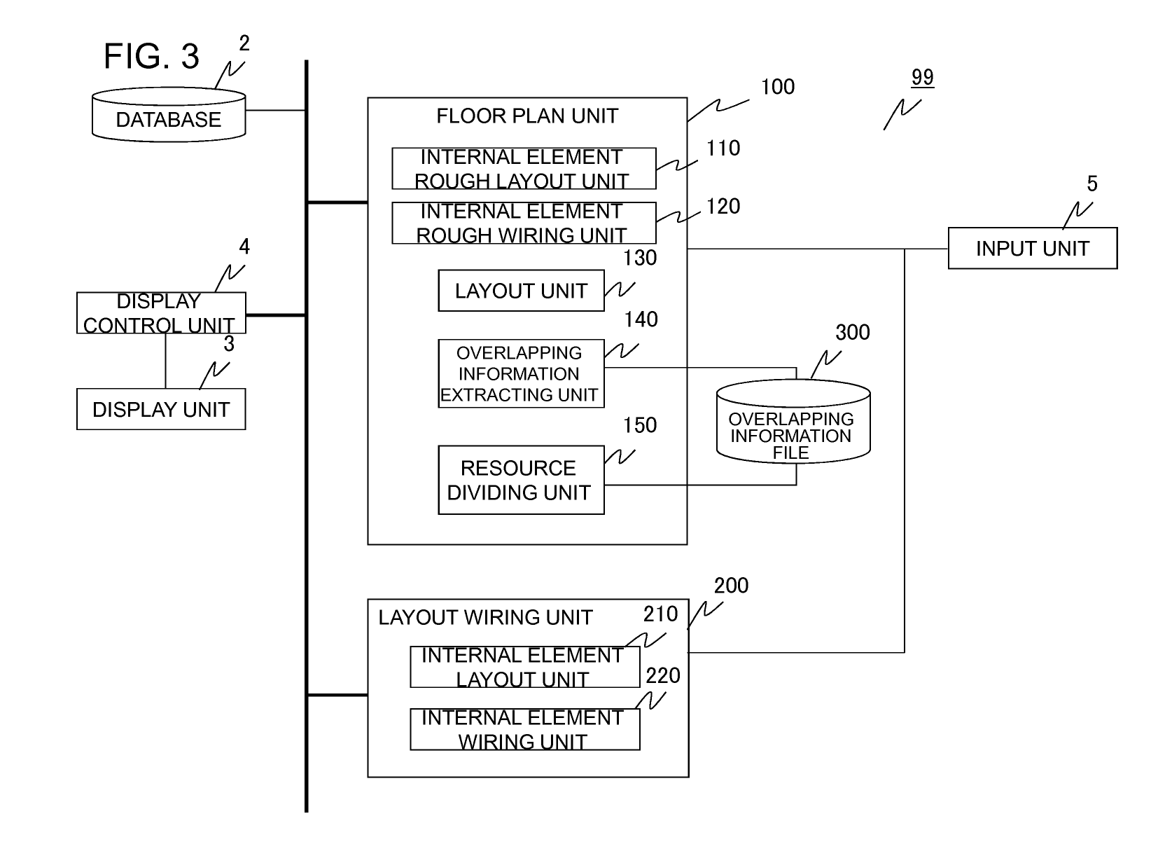

Referring to FIG. 3, the layout apparatus (99) is a layout apparatus of a semiconductor integrated circuit formed of a plurality of layer blocks divided according to respective functions, and may comprise: a layout unit (130) that performs layout of layer blocks such that at least two layer blocks overlap each other to form an overlapping area; an overlapping information extracting unit (140) that computes a layout wiring mixed loading ratio of internal elements of the layer blocks that include the overlapping area in part of their areas, and outputs the ratio as overlapping information; and a resource dividing unit (150) that divides the layout resources and the wiring resources of the overlapping area according to the overlapping information, wherein the layout unit (130) generates an overlapping area by mutually overlapping divided area parts of a plurality of layer blocks, computes the total number of internal element resources of the overlapping area and the total number of all internal elements within the overlapping area, and adjusts the position of the overlapping area so that the total number of internal element resources is greater than the number of all internal elements, the overlapping information extracting unit (140) outputs as overlapping information the internal element mixed loading ratio extracted from the number of internal elements within the divided area when the overlapping area is formed, and the resource dividing unit (150) performs resource division in accordance with the internal element mixed loading ratio described in overlapping information with respect to the overlapping area.

According to the layout method, the layout apparatus, and the program according to the present disclosure, it is possible to prevent interference of internal elements, and to curtail increase in time for correcting design constraint violations caused by position changes of the internal elements. Therefore, with the layout apparatus, the layout method and the program according to the present disclosure, it is possible to prevent an increase in design time when performing layout design while allowing a plurality of layer blocks to mutually overlap.

### Exemplary Embodiment

A description is given concerning a layout apparatus according to an exemplary embodiment, making reference to the drawings. FIG. 3 is a block diagram showing an example of a configuration of a layout apparatus 99 according to the present exemplary embodiment. Referring to FIG. 3, the layout apparatus 99 comprises a database 2, a display unit 3, a display control unit 4, an input unit 5, a floor plan unit 100, a layout wiring unit 200, and an overlapping information file 300.

The database 2 holds data related to a layout-target object that is designed by division layer design (layout-target object information), a netlist of a semiconductor integrated circuit as a floor plan target, and the like. Here, the layout-target object information at least includes: dimensions and shape of a layout-target object with respect to the semiconductor integrated circuit that is to be designed, information related to connection relationships with another layout-target object or the like, and information related to internal elements of the layout-target object in question (number, type, dimensions, connection relationship, etc. of the internal elements).

The display unit 3 displays information related to layout processing and wiring processing of an object for which layout is to be performed by the floor plan unit 100 and the layout wiring unit 200, and content of the overlapping information file 300 outputted by the flow plan unit 100.

The display control unit 4 controls display content of the display unit 3.

The input unit 5 is for a user of the layout apparatus 99 to input conditions to the floor plan unit 100 and the layout wiring unit 200.

The floor plan unit 100 comprises an internal element rough layout unit 110, an internal element rough wiring unit 120, a layout unit 130, an overlapping information extracting unit 140, and a resource dividing unit 150.

The internal element outline layout unit 110 performs a rough layout of internal elements for each layer block, and performs layout in a state where timing constraints and design constraints formed by design rules are relaxed. By performing layout without conforming to design constraints that should be satisfied at the point of design completion, it is possible to perform layout in a very short processing time, in comparison to a case of performing layout satisfying design constraints, by the internal element rough layout unit 110.

The internal element rough wiring unit 120 can perform rough wiring of internal elements for each layer block, and can perform wiring in a state where timing constraints and design constraints formed by design rules are relaxed, and since wiring may be performed without satisfying design constraints that should be satisfied at the point of design completion, processing time is very short in comparison to a case of performing wiring satisfying design constraints.

The layout unit 130 performs layout of the layer blocks in a mounting area so as to form an overlapping area where at least 2 of a plurality of layer blocks overlap each other. In this case, the layout unit 130 forms an overlapping area such that the total value of the number of layouts of all layer blocks included in the overlapping area is less than the total value of the layout resources of the overlapping area, and the total value of the number of wires of all layer blocks included in the overlapping area is less than the total value of the wiring resources of the overlapping area.

A layout resource is a reserved area in which a minimum unit instance can be arranged in an arbitrary area, and since all positions within the arbitrary area necessarily have some layout resource, the area can be represented as a collection of layout resources, and for example, in a case where the arbitrary area is a collection of 100 layout resources, the representation is such that a maximum of 100 of the minimum unit instances can be arranged in the area in question.

Furthermore, a wiring resource is a reserved area in which a minimum unit of wiring can be arranged in an arbitrary area, and since all positions within the arbitrary area necessarily have some wiring resource, the area can be represented as a collection of wiring resources, and for example, in a case where the arbitrary area is a collection of 100 wiring resources, the representation is such that a maximum of 100 of the minimum units of wiring can be arranged in the area in question.

The overlapping information extracting unit 140 recognizes an overlapping area generated by the layout unit 130, extracts overlapping information, and outputs to the overlapping information file 300.

The resource dividing unit 150 receives as input the overlapping information file 300 extracted by the overlapping information extracting unit 140, divides the internal element resources of the overlapping area within each layer block, and stores resource divided information in the database 2.

The layout wiring unit 200 is provided with an internal element layout unit 210 and an internal element wiring unit 220.

The internal element layout unit 210 performs layout of internal elements within each layer block so as to conform to timing constraints and design constraints formed of design rules. The internal element layout unit 210 performs layout in accordance with information of internal element resources divided by the resource dividing unit 150 and stored in the database 2.

The internal element wiring unit 220 performs wiring of internal elements within each layer block so as to conform to timing constraints and design constraints formed of design rules. The internal element wiring unit 220 performs wiring in accordance with information of internal element resources divided by the resource dividing unit 150 and stored in the database 2.

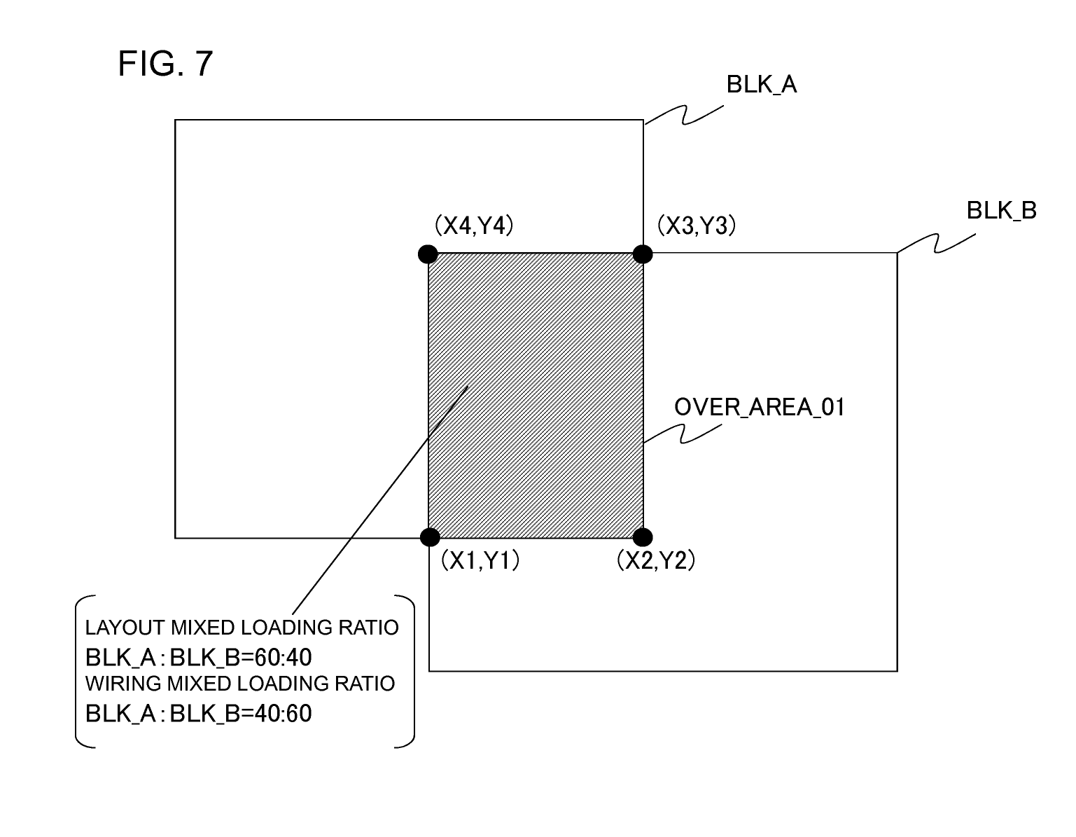

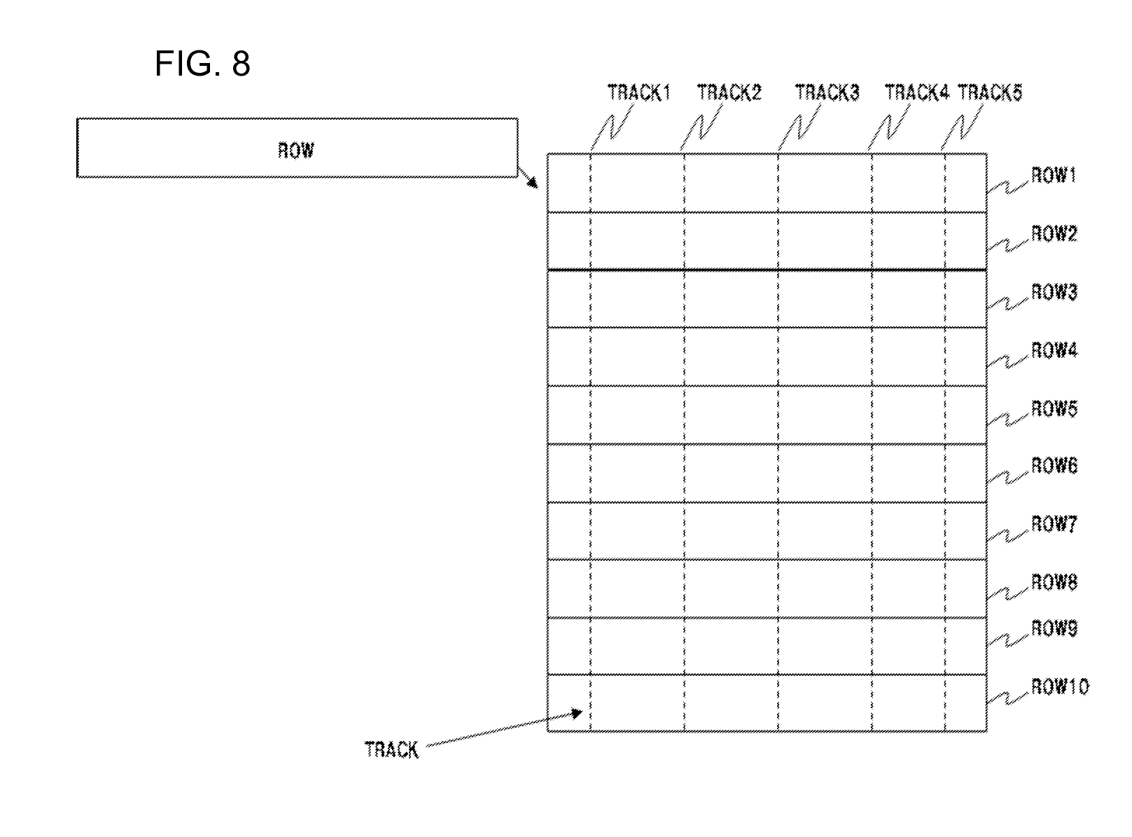

FIG. 8 is a schematic diagram showing a format of the overlapping information file 300 according to the layout apparatus 99; the described information is an example of the overlapping information file 300 of the schematic diagram in which area parts of layer block BLK_A and layer block BLK_B are arranged to overlap, and an overlapping area OVER_AREA_01 is generated, according to the layout apparatus 99 of the present disclosure as in FIG. 7.

FIG. 8 includes the name of the overlapping area, the position of the overlapping area, the layer block names of layer blocks that include the overlapping area in part of their areas, and a mixed loading ratio of internal elements of all layer blocks in the overlapping area.

The name of the overlapping area is arbitrarily specified by a user using the input unit 5 so as to enable a plurality of overlapping areas to be individually distinguished.

The position of the overlapping area is represented by coordinates of vertices of the overlapping area using the coordinates of the mounting area, and the position of the overlapping area, the layer block name of the layer blocks that include the overlapping area in a part of the areas, and the mixed loading ratio of internal elements of all layer blocks within the overlapping area are respectively described to fit the positions of the overlapping area.

The layer block name of layer blocks that include the overlapping area in a part of the areas is described for each name of overlapping areas.

With regard to the internal element mixed loading ratio, the layer block name and the mixed loading ratio of layout and wiring as a proportion occupied by the internal elements of the layer blocks with respect to all internal elements within the overlapping area, are described individually.

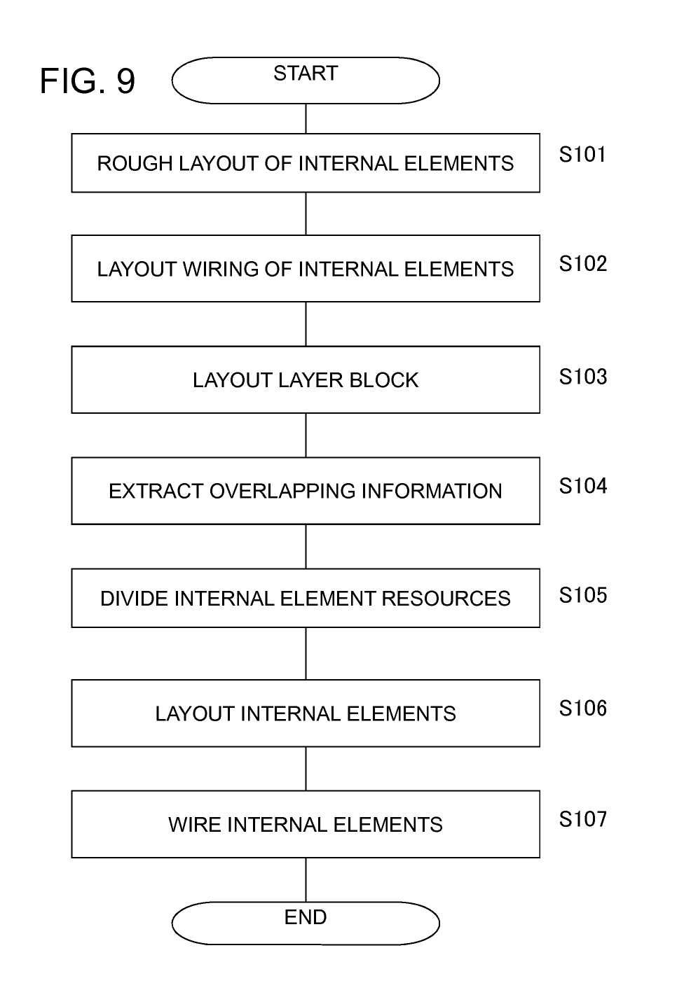

FIG. 9 is a flowchart showing an example of an operation of the layout apparatus 99.

The internal element rough layout unit 110 performs rough layout of the internal elements of all layer blocks possessed by the semiconductor integrated circuit in question, and stores a rough layout result in the database 2 (step S101).

The internal element rough wiring unit 120 performs rough wiring of the internal elements of all layer blocks possessed by the semiconductor integrated circuit in question, and stores a rough wiring result in the database 2 (step S102).

The layout unit 130 performs layout of the layer blocks such that the total value of the number of internal elements of all layer blocks included in the overlapping area is less than the total value of the internal element resources of the overlapping area, such that at least 2 of the layer blocks are arranged to overlap each other (step S103). The number of internal elements at the time of layout is determined using the rough layout result and the rough wiring result stored in the database 2 according to steps S101 and S102, and all areas of the respective layer blocks, in which the rough layout and the rough wiring have been executed, are divided with an arbitrary size (for example, the size of the divisions and the number of the divisions are arbitrarily set by the user via the input unit 5).

The overlapping information extracting unit 140 extracts overlapping information with respect to the overlapping area generated in step S103, and outputs to the overlapping information file 300 (step S104).

With the overlapping information file 300 outputted in step S104 as input, the resource dividing unit 150 extracts all internal element resources within the overlapping area, and performs resource division for the overlapping area by dividing the internal element resources in accordance with the internal element mixed loading ratio of each layer block, to be stored as resource division information in the database 2 (step S105).

The internal element layout unit 210 performs layout of internal elements of all layer blocks possessed by the semiconductor integrated circuit in question, using the resource division result of the overlapping area stored in the database 2 (step S106).

The internal element wiring unit 220 performs wiring of internal elements of all layer blocks possessed by the semiconductor integrated circuit in question, using the resource division result of the overlapping area stored in the database 2 (step S107).

### EXAMPLE

A description is given concerning operation of the layout apparatus 99 according to the abovementioned exemplary embodiment, based on a specific example and making reference to the drawings.

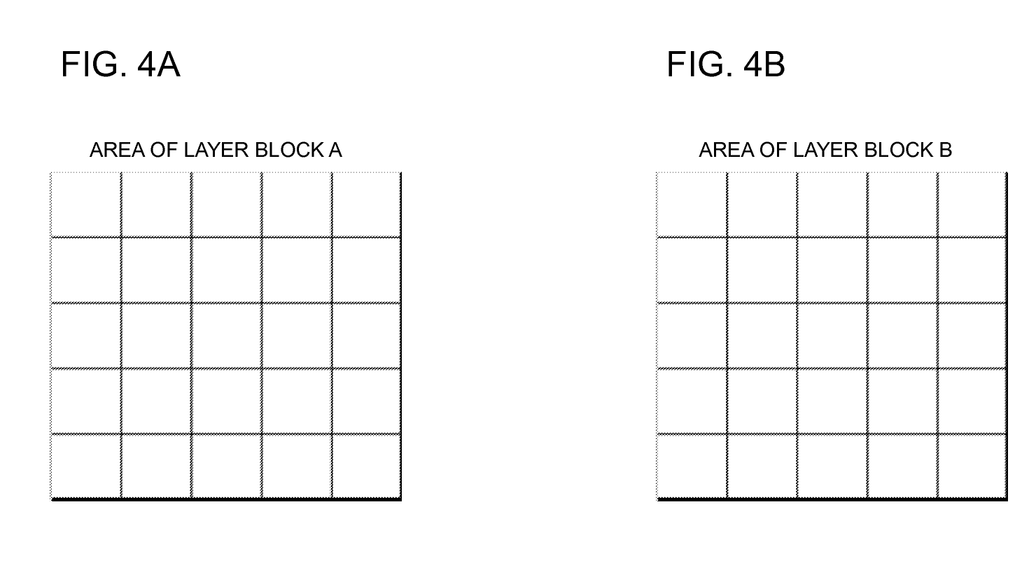

FIG. 4A shows a case where the area of a layer block A is divided into 25 divided areas of 5 rows and 5 columns, with respect to step S103. FIG. 4B shows a case where the area of a layer block B is divided into 25 divided areas of 5 rows and 5 columns. Here, as an example, there are 10 layout resources and 10 wiring resources within each of the divided areas. Next, the number of internal elements within the divided areas is computed. In this case, since it is sufficient to extract the number of layouts and wires within an area, physical positions are not necessary.

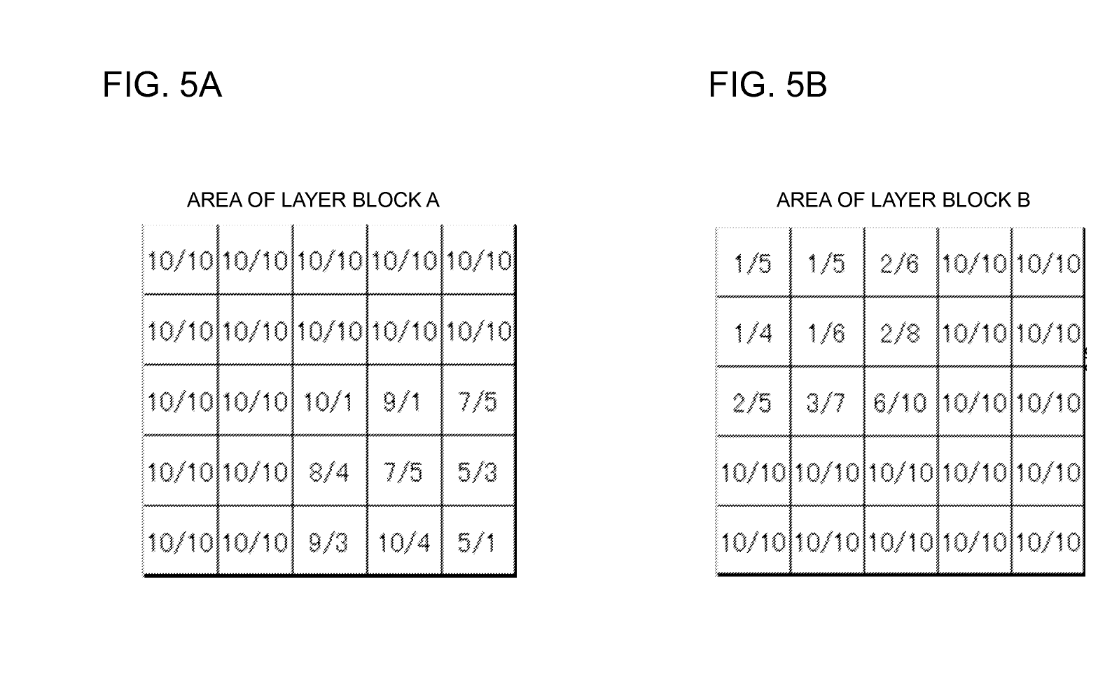

FIG. 5A expresses a number of layouts and a number of wires for each divided area of the layer block A, with respect to step S103. FIG. 5B expresses a number of layouts and a number of wires for each divided area of the layer block B. In FIG. 5A, in a case where 9/1 is noted within a divided area, for example, this indicates that there are 9 layouts and 1 wire present in the divided area. Next, the layout unit 130 generates an overlapping area by the layer block A and the layer block B overlapping each other in a part of the divided areas. In this case, the layout unit 130 computes the total number of internal element resources of the overlapping area and the total number of internal elements within the overlapping area, and adjusts positions such that the total number of internal element resources is greater than the total number of internal elements.

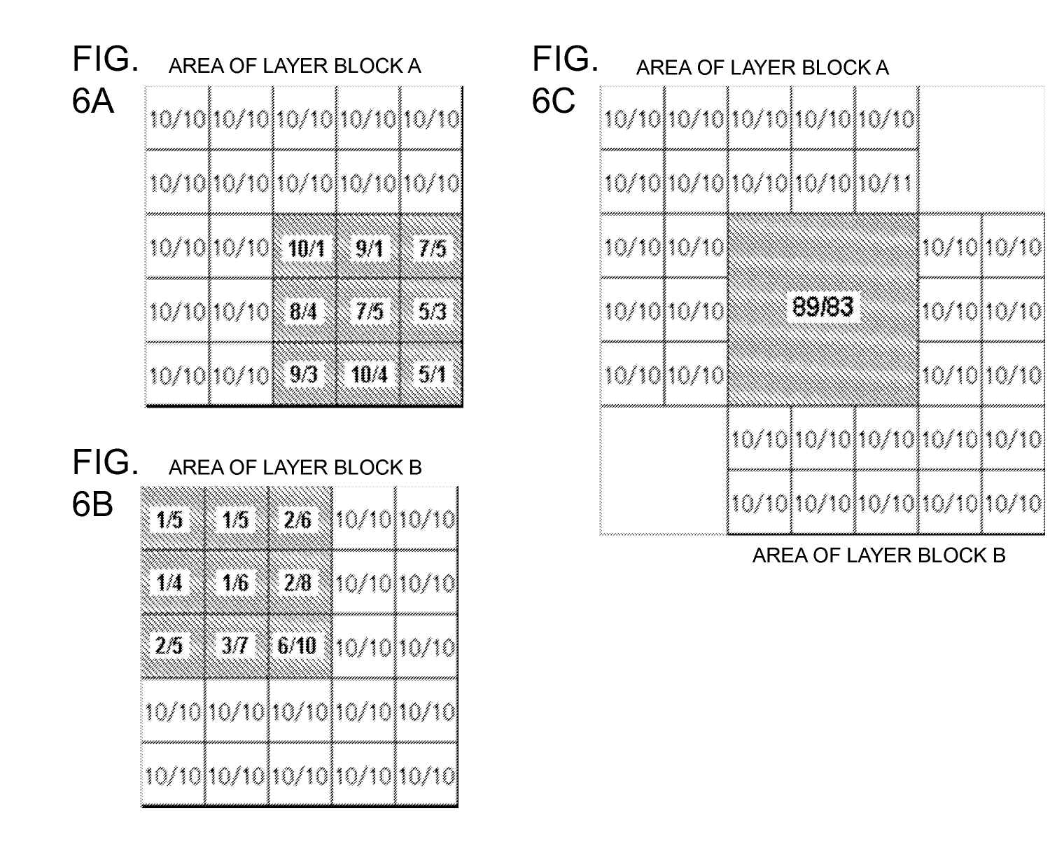

FIG. 6A expresses the number of internal elements in the layer block A and in each of the divided areas, with respect to step S103. FIG. 6B expresses the number of internal elements in the layer block B and in each of the divided areas. Furthermore, FIG. 6C represents positions of the layer block A and the layer block B being changed, and divided areas of parts of each being overlapped to cause an overlapping area. Slanted line portions of FIG. 6A to FIG. 6C indicate areas that form overlapping areas when an overlapping area is generated.

In FIG. 6C, 3×3=9 divided areas in each of the layer block A and layer block B overlap, and the total number of resources of internal elements of the overlapping area in question is 10×9=90. On the other hand, totaling the internal elements included in all the divided areas within the overlapping area in question gives a total of 89 layouts, and a total of 83 wires. Therefore, there are fewer of both layouts and wires than the total number of resources of the internal elements.

FIG. 7 shows an example where partial areas of the layer block BLK_A and the layer block BLK_B are arranged to overlap, by the layout apparatus 99, and an overlapping area OVER_AREA_01 is generated.

The position of the overlapping area OVER_AREA_01 is uniquely expressed by (X1, Y1), (X2, Y2), (X3, Y3), and (X4, Y4), the coordinates of respective vertices. It is to be noted that even in a case where the overlapping area has a complicated shape such as a polygon or the like, it is possible to represent the position of the overlapping area using the coordinates of all the vertices.

Layer blocks that include the overlapping area in a part of the area thereof are layer blocks BLK_A and BLK_B.

In step S104, the internal element mixed loading ratio is extracted from the number of internal elements within a divided area when an overlapping area is formed with respect to the overlapping information extracting unit 140. Concerning numerical values given in FIG. 4, if the mixed loading ratio is specifically computed, the layer block BLK_A is 70/89 and the layer block BLK_B is 19/89 with regard to layout, and the layer block BLK_A is 27/83 and the layer block BLK_B is 56/83 with regard to wiring. Here, in order to simplify the description, for the overlapping area OVER_AREA_01, the layer block BLK_A is assumed to be 60% and the layer block BLK_B is assumed to be 40% with regard to layout, and the layer block BLK_A is assumed to be 40% and the layer block BLK_B is assumed to be 60% with regard to wiring.

In step S105, for all internal element resources of the overlapping area OVER_AREA_01, all layout resources are divided such that layout resources for the layer block BLK_A are 60%, and layout resources for the layer bock BLK_B are 40%. Next, all wiring resources are divided such that wiring resources for the layer block BLK_A are 40%, and wiring resources for the layer block BLK_B are 60%.

FIG. 8, in step S105, represents layout areas as a ROW collection, and represents wiring resources as a TRACK collection, with respect to internal element resources of an arbitrary overlapping area. In step S106, when the internal element layout unit 210 performs layout processing, an instance is arranged in a ROW. On the other hand, in step S107, when the internal element wiring unit 220 performs wiring processing, wiring is arranged in a TRACK.

Layout resources are represented by a collection of 10 ROWs, which is the total of ROW1 to ROW 10, and all layout resources are used at the point in time when instances are arranged in all the 10 ROWs. On the other hand, wiring resources are represented by a collection of 5 TRACKs, which is the total of TRACK1 to TRACK5, and all wiring resources are used at the point in time when wiring is arranged in all the 5 TRACKs.

In step S105, the resource dividing unit 150 divides the ROWs and TRACKs defined for the overlapping area in accordance with the internal element mixed loading ratio described in the overlapping information file 300.

For example, in the overlapping area OVER_AREA_01, in a case where the layout mixed loading ratio of the layer block BLK_A is 60%, the layout mixed loading ratio of the layer block BLK_B is 40%, the wiring mixed loading ratio of the layer block BLK_B is 40%, and the wiring mixed loading ratio of the layer block B is 60%, the resource dividing unit 150 assigns ROW1, ROW2, ROW4, ROW5, ROW7 and ROW8, as layout resources for the layer block BLK_A, in accordance with the mixed loading ratio in question. Next, the resource dividing unit 150 assigns ROW3, ROW6, ROW9 and ROW10 as layout resources for the layer block BLK_B.

The resource dividing unit 150 may arbitrarily determine assignment of respective ROWs to any layout resource of the layer block BLK_A and the layer block BLK_B, if the overall mixed loading ratio is kept. However, in a case where only the layout resources are assigned and the wiring resources are not assigned, the assigned layout resources are wasted. In the same way, in a case where only the wiring resources are assigned and the layout resources are not assigned, the assigned wiring resources are wasted. Accordingly, the resource dividing unit 150 preferably performs the assigning as uniformly as possible, such that one of the internal element resources (wiring resource or layout resource) is not biased to a local area. By performing the assigning in this way, it is possible to prevent resources from being wastefully consumed by only one of the wiring resources and the layout resources being assigned with respect to one layer block, in the overlapping area.

With regard to the wiring resources also, TRACK1, TRACK2 and TRACK4 are assigned as wiring resources for the layer block BLK_A by a dividing method the same as the layout resources, and TRACK3 and TRACKS are assigned as wiring resources of the layer block BLK_B.

The layout apparatus 99 of the present exemplary embodiment exclusively divides the internal element resources in accordance with the internal element mixed loading ratio of the overlapping area, before carrying out layout and wiring of internal elements of the layer blocks. In this case, there is no mutual interference of internal elements within respective layer blocks in the overlapping area after carrying out the layout and wiring of internal elements, and there is no occurrence of change in position of the internal elements with the aim of resolving interference and design constraint violations accompanying change in position. Therefore, due to the layout apparatus 99 it is possible to curtail increase in the amount of design time for the process of correcting design constraint violations and it is possible to curtail increase in the design time necessary for layout of an entire logic circuit (semiconductor integrated circuit).

The disclosure of the above Patent Literature is incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.
2 database
3 display unit
4 display control unit
5 input unit
10, 99 layout apparatus
100 floor plan unit
110 internal element rough layout unit
120 internal element rough wiring unit
13, 130 layout unit
14, 140 overlapping information extracting unit
15, 150 resource dividing unit
200 layout wiring unit
210 internal element layout unit
220 internal element wiring unit
300 overlapping information file

What is claimed is:

1. A layout method, the method comprising performing layout of a plurality of layer blocks each including a plurality of internal elements, while allowing mutual overlapping, with respect to a mounting area where internal element resources, to which internal elements can be assigned, are arranged, the method further comprising:
arranging, in a case where a first layer block and a second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area, and
assigning the internal element resources included in the overlapping area to the first layer block and the second layer block, in accordance with a ratio of the number of the first internal elements to the number of the second internal elements.

2. The layout method according to claim 1, wherein
the internal elements include a layout element and a wiring element; and
the internal element resources include a layout resource to which the layout element can be assigned and a wiring resource to which the wiring element can be assigned.

3. The layout method according to claim 2, wherein
the arranging comprises arranging the first layer block and the second layer block such that a sum of a number of first layout elements included in the overlapping area, among layout elements of the first layer block, and a number of second layout elements included in the overlapping area, among layout elements of the second layer block, is not greater than a number of layout resources included in the overlapping area, and that a sum of a number of first wiring elements included in the overlapping area, among wiring elements of the first layer block, and a number of second wiring elements included in the overlapping area, among wiring elements of the second layer block, is not greater than a number of wiring resources included in the overlapping area.

4. The layout method according to claim 3, wherein
the assigning comprises assigning layout resources included in the overlapping area to the first layer block and the second layer block in accordance with a ratio of the number of the first layout elements to the number of the second layout elements, and assigning wiring resources included in the overlapping area to the first layer block and the second layer block in accordance with a ratio of the number of the first wiring elements to the number of the second wiring elements.

5. The layout method according to claim 4, wherein
the assigning comprises assigning layout resources included in the overlapping area to the first layer block and the second layer block, such that a ratio of the layout resources assigned to the first layer block to the layout resources assigned to the second layer block is uniform in each part of the overlapping area.

6. The layout method according to claim 4, wherein
the assigning comprises assigning wiring resources included in the overlapping area to the first layer block and the second layer block, such that a ratio of the wiring resources assigned to the first layer block to the wiring resources assigned to the second layer block is uniform in each part of the overlapping area.

7. A layout apparatus, the layout apparatus performing layout of a plurality of layer blocks each including a plurality of internal elements, while allowing mutual overlapping, with respect to a mounting area where internal element resources, to which internal elements can be assigned, are arranged, the apparatus comprising:
a layout unit that arranges, in a case where a first layer block and a second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area;
an overlapping information extracting unit that computes a ratio of the number of the first internal elements to the number of the second internal elements; and
a resource dividing unit that assigns the internal element resources included in the overlapping area to the first layer block and the second layer block, in accordance with the ratio.

8. The layout apparatus according to claim 7, wherein
the internal elements include a layout element and a wiring element; and
the internal element resources include a layout resource to which the layout element can be assigned, and a wiring resource to which the wiring element can be assigned.

9. The layout apparatus according to claim 8, wherein
the layout unit arranges the first layer block and the second layer block such that a sum of a number of first layout elements included in the overlapping area, among layout elements of the first layer block, and a number of second layout elements included in the overlapping area, among layout elements of the second layer block, is not greater than a number of layout resources included in the overlapping area, and that a sum of a number of first wiring elements included in the overlapping area, among wiring elements of the first layer block, and a number of second wiring elements included in the overlapping area, among wiring elements of the second layer block, is not greater than a number of wiring resources included in the overlapping area.

10. The layout apparatus according to claim 9, wherein
the overlapping information extracting unit computes a ratio of the number of the first layout elements to the number of the second layout elements as a first ratio, and computes a ratio of the number of the first wiring elements to the number of the second wiring elements as a second ratio, and
the resource dividing unit assigns layout resources included in the overlapping area to the first layer block and the second layer block in accordance with the first ratio, and assigns wiring resources included in the overlapping area to the first layer block and the second layer block in accordance with the second ratio.

11. A non-transitory computer-readable storage medium that stores a program, the program causing a computer to execute performing layout of a plurality of layer blocks each including a plurality of internal elements, while allowing mutual overlapping, with respect to a mounting area where internal element resources, to which internal elements can be assigned, are arranged, the program further causing the computer to execute:
arranging, in a case where a first layer block and a second layer block overlap in an overlapping area, the first layer block and the second layer block such that a sum of a number of first internal elements included in the overlapping area, among internal elements of the first layer block, and a number of second internal elements included in the overlapping area, among internal elements of the second layer block, is not greater than a number of internal element resources included in the overlapping area, and
assigning the internal element resources included in the overlapping area to the first layer block and the second layer block, in accordance with a ratio of the number of the first internal elements to the number of the second internal elements.
